(19) United States
(12) Patent Application Publication
(10) Pub. No.: US 2026/0257222 A1
(43) Pub. Date: Sep. 3, 2026

(54) Centrifugal Microfluidic Biochip

(71) Applicant: DERMAGNOSTIX GMBH, Friedberg (DE)

(72) Inventors: Katharina DORMANNS, Friedberg (DE); Verena HACKERT, Friedberg (DE); Lucca WEBER, Friedberg (DE); Natalie GARZORZ-STARK, Friedberg (DE)

(21) Appl. No.: 18/713,323

(22) PCT Filed: Nov. 29, 2022
(86) PCT No.: PCT/DE2022/100890

§ 371 Date: May 24, 2024

(30) Foreign Application Priority Data
Dec. 16, 2021 (DE) 102021133494.2

(51) Int. Cl. B01L 3/00; B01L 7/00

(52) U.S. Cl. CPC B01L 3/50273; B01L 7/00; B01L 2200/0605; B01L 2200/0621; B01L 2300/0803; B01L 2300/0867; B01L 2300/14; B01L 2300/1827; B01L 2400/0409; B01L 2400/0445

(57) ABSTRACT

The invention relates to a method for completely transferring a liquid received by a first cavity of a centrifugal microfluidic chip to a second cavity of the centrifugal microfluidic chip by of a liquid-carrying conduit that connects the first cavity and the second cavity.

The invention relates to a method for the complete transfer of a liquid taken up by a first cavity of a centrifugal microfluidic biochip into a second cavity of the centrifugal microfluidic biochip by means of a liquid-conducting conduit connecting the first cavity to the second cavity. In addition, the invention relates to a system comprising a centrifugal microfluidic biochip having a temperature-controllable first cavity adapted to receive a liquid, a second cavity adapted to receive liquid pumped from the first cavity into the second cavity, and a liquid-carrying conduit connecting the first cavity to the second cavity, and a centrifuge having a receptacle receiving the centrifugal microfluidic biochip.

Centrifugal microfluidic biochips, also known as centrifugal microfluidic bio-disks or centrifugal microfluidic test cartridges, are used in medical diagnostics as part of lab-on-a-chip or lab-on-a-disk systems. These have a (micro)fluidic system into which a sample is fed, which can be automatically processed according to a predetermined flow trace using an analyzer which among other things is acting as a centrifuge with a rotation device adapted to the bio-disk. Depending on the problem to be addressed, the Centrifugal Microfluidic Biochip is equipped with the appropriate reagents, which are kept in liquid form in stick packs, also known as sachets or sealed-edge bags. These stick packs are designed in such a way that they open when pressure is acting to the sealing seam of the stick pack while the centrifugal microfluidic biochip is rotating and a predetermined temperature is also applied to the sealing seam, releasing the contents into the fluidic system of the centrifugal microfluidic biochip.

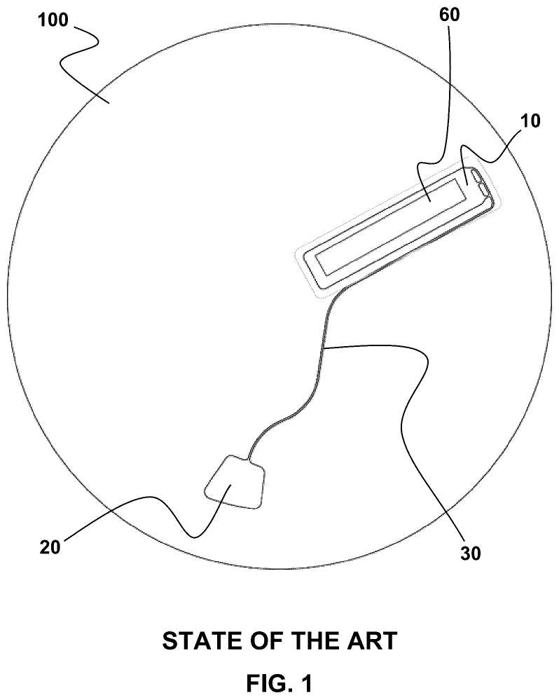

To illustrate this, the basic structure of a prior art centrifugal microfluidic biochip in the form of a circular disk is shown in FIG. 1. FIG. 1 shows in particular a centrifugal microfluidic biochip 100 with a temperature-controllable first cavity 10 in the form of a chamber, in which a stick pack 60 holding a reagent is arranged. The first cavity 10 is connected to a second cavity 20, also designed as a chamber, via a liquid-conducting conduit 30 connecting the cavities 10, 20, so that with suitable process parameters, namely rotational frequency, temperature and pressure in the first cavity, an (inwardly directed) liquid transport can take place from the first cavity 10 into the second cavity 20.

A particular problem with the use of stick packs is that they cannot be opened to the second, meaning that the time of opening and therefore the volume of air trapped in the stick pack chamber varies. As a result, the pressure that defines the amount of liquid to be transported, i.e. the reagent or reagents, cannot be precisely predetermined and it is therefore often not possible, at least not in one step, to transport a precisely defined amount of liquid or reagent from a first cavity to a second cavity in a controlled manner.

In practice, several cycles of sequential heating and cooling are carried out for a complete liquid transport in order to achieve a pressure for the transport of partial quantities of the liquid held in the stick pack. Typically, the stick pack is opened at a temperature of >50° C. and a rotational frequency of over 30 Hz, whereupon the rotational frequency is reduced to below 30 Hz in order to effect liquid transport from the first cavity, i.e. the first chamber, into the second cavity, i.e. the second chamber. The first cavity is then cooled in order to suck air out of the remaining fluidic system, whereby the fluid in the stickpack chamber also degasses, so that sufficient pressure is subsequently available again for pumping and a new heating process can follow. As the volume transported per cycle is not known, the only way to ensure that the entire volume of a stick pack can be transported completely is to repeat several cycles, which is a very time-consuming process. This is particularly problematic when using several stick packs.

If, on the other hand, defined quantities are to be transported (taking into account the stoichiometric balance), the first cavity is cooled before the first pumping process in order to draw in the necessary volume of air and generate the necessary pressure for the transport process during the subsequent heating process. This mechanism is limited by the maximum air volume of the first cavity at the respective temperature.

What both approaches have in common is that long processing times are required for the liquid transport in addition to the actual processing of the samples, resulting in long waiting times for the expected analysis result.

Therefore it is an object of the invention to improve the liquid transport within a centrifugal microfluidic biochip in such a way that it can take place in a defined, complete and rapid manner.

According to the invention, this object is solved by the method with the features of claim 1 and the system with the features of claim 7. The dependent each disclose advantageous embodiments of the invention.

The basic idea of the invention is to retain, in addition to the volume of air present in the first cavity, a further volume of air in a third cavity, which is available, in particular exclusively for the complete transport of a liquid from the first cavity into the second cavity, when or only after it is heated. If, in particular, a stick pack is opened in the first cavity by rotation and temperature, the gas stored and initially retained in the third cavity acts as an additional drive for the liquid transport. This design increases the efficiency of the liquid transport while simultaneously saving time in the process to be carried out using the centrifugal microfluidic biochip.

According to the invention, a method is proposed for transferring a liquid received by a first cavity of a centrifugal microfluidic biochip into a second cavity of the centrifugal microfluidic biochip by means of a liquid-carrying conduit connecting the first cavity to the second cavity, comprising the following steps:
a. generating a predetermined gas and/or vapor pressure driving the liquid received by the first cavity from the first cavity through the liquid-carrying conduit to the second cavity by tempering the first cavity to a first predetermined temperature while simultaneously tempering a gas-filled third cavity, which is connected to the first cavity by means of a gas-carrying conduit, to a second predetermined temperature which is lower than the first predetermined temperature,
b. generating a predetermined gas pressure in the third cavity by tempering the third cavity to a third predetermined temperature, and
c. allowing the gas pressure generated in the third cavity to act on the interior of the first cavity by means of the gas-conducting conduit connecting the third cavity to the first cavity and thereby causing the liquid received by the first cavity to be completely transferred from the first cavity through the liquid-conducting conduit into the second cavity.

The method is preferably carried out while rotating the centrifugal microfluidic biochip. In particular, step a. takes place while rotating the centrifugal microfluidic biochip at a predetermined first rotational frequency. Likewise, it is preferably provided that step b. and/or step c. takes place while rotating the centrifugal microfluidic biochip at a predetermined second rotational frequency. Most preferably, in combination, it is provided that the second rotational frequency is lower than the first rotational frequency.

Furthermore, it is preferably provided that step b or step c involves acting on a device controlling the passage of gases through the gas-conducting conduit, as a result of which tempered gas in the third cavity passes through the gas-conducting conduit into the first cavity. The device is designed, for example, as a valve or as a temperature-instable seal, with reference being made, regarding its structural design, to the following description of the centrifugal microfluidic biochip designed in accordance with the invention.

It goes without saying that steps a, b and c can run simultaneously. However, it is preferable that steps b and c are only carried out after step a.

Further, according to the invention there is provided a system comprising a Centrifugal Microfluidic Biochip having a temperature-controllable first cavity designed to receive a liquid, a second cavity designed to receive liquid pumped from the first cavity into the second cavity, anda liquid-conducting conduit connecting the first cavity to the second cavity, a gas-filled third cavity connected to the first cavity by means of an exclusively gas-conducting conduit, and a centrifuge having a receptacle receiving the centrifugal microfluidic biochip, having a first device for temperature control of the first cavity of the centrifugal microfluidic biochip and a second device for temperature control of the third cavity of the centrifugal microfluidic biochip, and a controller which is designed in a first step for generating a predetermined gas and/or vapor pressure driving a liquid received by the first cavity from the first cavity through the liquid-carrying conduit to the second cavity by tempering the first cavity to a first predetermined temperature while simultaneously tempering the gas-filled third cavity to a second predetermined temperature which is lower than the first predetermined temperature, and, in a second step for generating a predetermined gas pressure in the third cavity by tempering the third cavity to a third predetermined temperature, in order to transfer the liquid received by the first cavity from the first cavity completely into the second cavity through the liquid-conducting conduit.

The independently temperature-controlled arrangement of the third cavity is achieved primarily by the third cavity being arranged at a distance from the first cavity in such a way that a temperature input in the area of the first cavity causes no or only an insignificant temperature increase (of a maximum of 5° C., for example) in the third cavity. The first cavity and the third cavity are preferably arranged in different sectors of a centrifugal microfluidic biochip, which is preferably designed as a circular disk, and can alternatively or additionally preferably be arranged in different radial sections of the biochip. In addition, heat-conducting structures can be provided between the first cavity and the third cavity, which prevent heat input from the first cavity into the third cavity and dissipate heat radiating from the first cavity into an area of the centrifugal microfluidic biochip in which a temperature increase is not critical.

Furthermore, the centrifugal microfluidic biochip can preferably have a separate temperature control device in the form of a heating element that controls the temperature of the third cavity in addition to a heating element that controls the temperature of the first cavity. The respective heating element can preferably be designed as an electrically conductive heating element which interacts with a magnet arranged in the centrifuge driving the centrifugal microfluidic biochip to generate an electric current in the heating element, as described in principle in EP 3 549 673A1 . Alternatively, the respective heating element can also be connected to a power source arranged on the centrifugal microfluidic biochip or to such a power source arranged outside the centrifugal microfluidic biochip.

In any case, the first cavity is preferably designed in such a way that it is set up to accommodate a liquid-filled stick pack. The stick pack is a sealed-edge pouch conventionally used in this context, which contains at least one reagent required for the respective analytical method. The first cavity and the second cavity can be in any spatial relationship to each other, but are preferably arranged at opposite positions in relation to the center of rotation of the biochip, so that with respect to the center of rotation of the biochip—as is known—an inwardly directed liquid transport takes place, which is dependent on the temperature, the pressure in the first cavity, the pressure in the third cavity and the rotation of the biochip.

The third cavity is filled with a gas, in particular with air, and in particular has a blind end, so that the third cavity communicates exclusively with the first cavity. It is preferably provided that the gas-conducting conduit connects the first cavity to a section of the third cavity close to the center of rotation of the centrifugal microfluidic biochip, whereby alternatively or additionally it is also preferably provided that the gas-conducting conduit connects the third cavity to a section of the first cavity remote from the center of rotation of the centrifugal microfluidic biochip.

In particular, the centrifugal microfluidic biochip can be equipped with a device that controls the passage of gases through the gas-conducting conduit, which can preferably be designed as a check valve or a temperature-instable septum. On the one hand, the device makes it possible to prevent fluid transport from the first cavity into the third cavity. On the other hand, the device also makes it possible to establish communication between the third cavity and the first cavity only at a predetermined point in time, in particular only after the stick pack has been opened due to temperature and pressure acting on the sealing seam caused by rotation. In particular, a temperature-instable septum can be provided for this purpose, which breaks down when temperature is introduced into the third cavity and establishes fluid communication between the third cavity and the first cavity. By applying temperature to the third cavity, the control also acts on the device that controls the passage of gases through the gas-conducting conduit.

In any case, the gas held in the third cavity, which is present in particular as air, acts as an additional propellant that expels the liquid received by the first cavity from the first cavity and transports it completely into the second cavity.

In this context, according to a first preferred embodiment, the centrifugal microfluidic biochip has an electrically conductive first heating element for controlling the temperature of the first cavity and an electrically conductive second heating element for controlling the temperature of the third cavity and the centrifuge has at least one magnet for generating an electric current in the first heating element and in the second heating element.

Alternatively, it is highly preferred that only the centrifuge receptacle has a first heating element for temperature control of the first cavity and a second heating element for temperature control of the third cavity, which can be controlled independently of each other to generate different temperatures. In this case, the centrifugal microfluidic biochip does not have its own structure for generating temperatures.

In the context of the present invention, the term cavity represents a section of the fluidic system of a Centrifugal Microfluidic Biochip. For example, the cavities can be chambers or conduits of the fluidic system that connect sections of the fluidic system with each other. In particular, the first cavity relating to the invention is a fluid-conducting conduit or a chamber, and the second cavity is a chamber or a fluid-conducting conduit. The liquid-carrying conduit connecting the two cavities, for example two chambers or a chamber and a conduit, does not necessarily have to be of a certain length-in fact, the liquid-carrying conduit connecting the cavities is a section that marks a transition from the first cavity to the second cavity. This can also be an opening in a wall of the first cavity, for example.

The invention is explained in more detail below with reference to a particularly preferred embodiment shown in the accompanying drawings. They show:

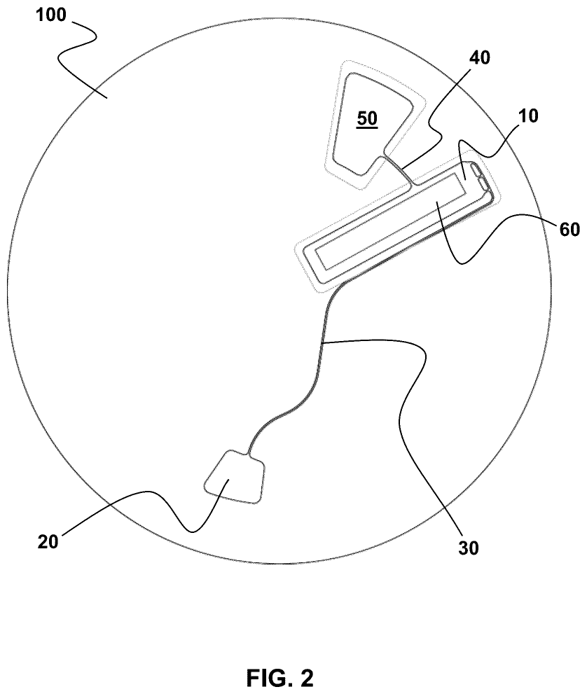

FIG. 2 a schematic view of a particularly preferably designed centrifugal microfluidic biochip according to the invention with a stickpack taken up by the centrifugal microfluidic biochip in the initial state;

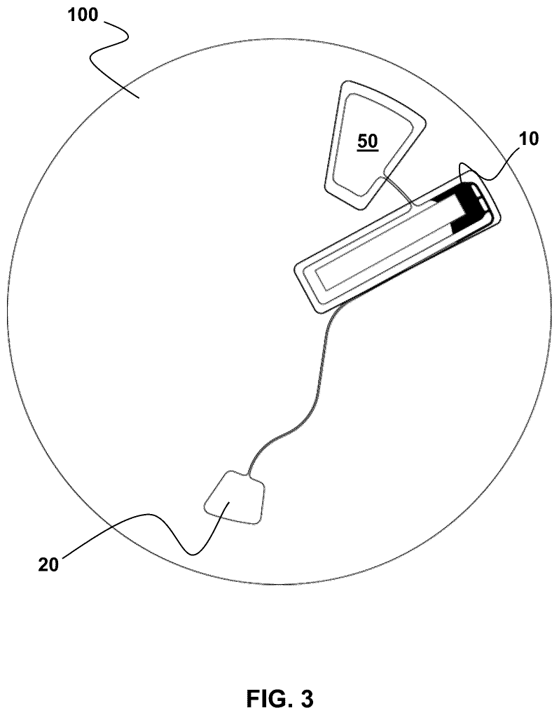

FIG. 3 a schematic view of the centrifugal microfluidic biochip shown in FIG. 1 after opening the stickpack;

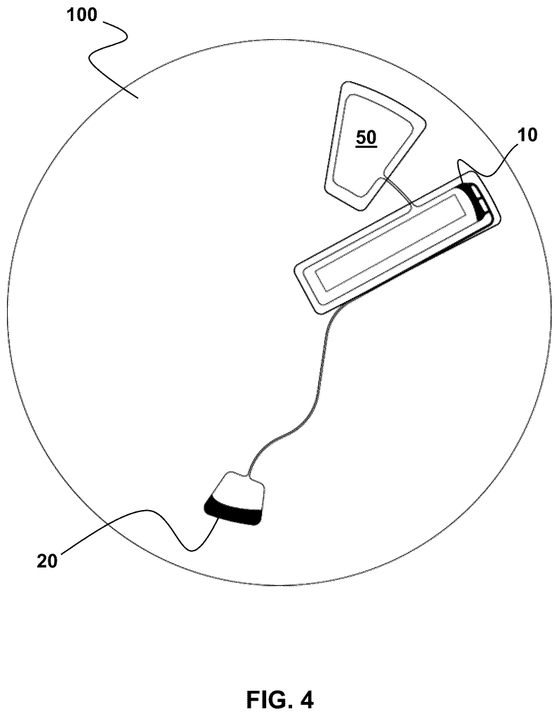

FIG. 4 a schematic view of the centrifugal microfluidic biochip shown above during the propellant-assisted expulsion of the liquid discharged from the stickpack from the first cavity formed as a stickpack chamber; and

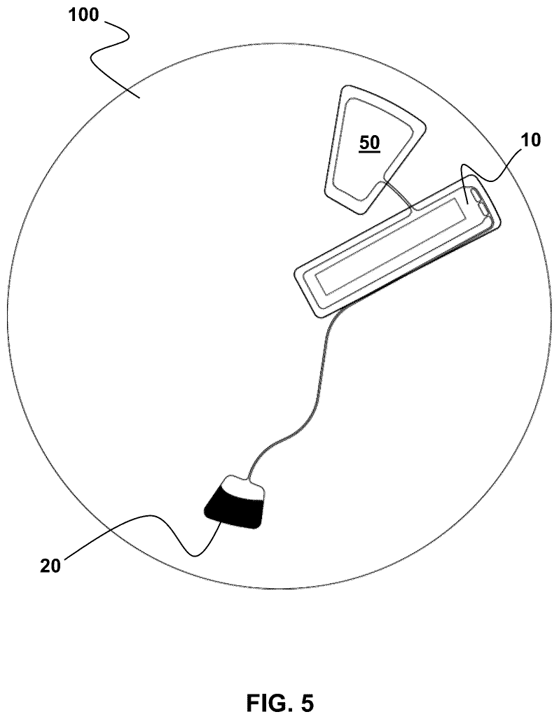

FIG. 5 a schematic view of the Centrifugal Microfluidic Biochip, in which the liquid held in the stickpack has been completely transferred to the second cavity.

FIG. 2 shows a schematic view of a particularly preferably designed centrifugal microfluidic biochip according to the invention with a stickpack taken up by the centrifugal microfluidic biochip in the initial state. The centrifugal microfluidic biochip 100, which is designed as a circular disk, has-as is known-a temperature-controllable first cavity 10—hereinafter referred to as first chamber 10—which is designed as a stickpack chamber and accommodates a stickpack 60 storing a liquid. Furthermore, a second cavity 20—hereinafter referred to as second chamber 20—is provided, which is set up to receive liquid pumped from the first chamber 10 into the second chamber 20, wherein a liquid-conducting conduit 30 connects the first chamber 10 to the second chamber 20. According to the invention, the centrifugal microfluidic biochip 100 further comprises a gas-filled third cavity 50—hereinafter referred to as third chamber 50—which is connected to the first chamber 10 by means of a gas-conducting conduit 40 and which specifically is filled with air and can be temperature-controlled independently of the first chamber 10.

It can also be seen that the third chamber 50 has a blind end and is arranged directly adjacent to the first chamber 10. The first chamber 10 and the second chamber 20, on the other hand, are arranged at opposite positions in relation to the center of rotation of the biochip 10.

The gas-conducting conduit 40 connects the first chamber 10 with a section of the third chamber 50 close to the pivot point of the centrifugal microfluidic biochip 10, wherein the gas-conducting conduit 40 connects the third chamber 50 with a section of the first chamber 10 remote from the pivot point of the centrifugal microfluidic biochip 10. The gas-conducting conduit 40 thus starts at the third chamber 50 in a section which is close to the center of rotation of the centrifugal microfluidic biochip 10, the section starting from the point of the third chamber 50 closest to the center of rotation corresponding to at most half the radial extent of the third chamber 50. On the other hand, the gas-conducting conduit 40 starts at the first chamber 10 in a section which is remote from the center of rotation of the centrifugal microfluidic biochip 10, the section starting from the point of the first chamber 10 furthest away from the center of rotation corresponding to at most half the radial extent of the third chamber 50.

During processing of the centrifugal microfluidic biochip 100, the stickpack 60 is opened by rotating the biochip 100 about its axis of rotation and introducing temperature into the first chamber 10 cf. FIG. 3 and the liquid emerging from the stickpack 60 is driven out of the first chamber 10 through the liquid-conducting conduit 30 to the second chamber 20 by forming a predetermined gas and/or vapor pressure prevailing in the first chamber 10.

FIG. 4 shows an intermediate step in the processing of the biochip 100, in which in the gas-filled third chamber 50, which is connected to the first chamber 10 by means of the gas-conducting conduit 40, a predetermined gas pressure is generated by tempering the third chamber 50 to a second predetermined temperature (independently of the first chamber 10).

This gas pressure generated in the third chamber 50 acts as a drive when the tempered gas is allowed to act on the interior of the first chamber 10 by means of the gas-conducting conduit 40 connecting the third chamber 50 to the first chamber 10, as a result of which the liquid received by the first chamber 10 is ultimately completely transferred from the first chamber 10 through the liquid-conducting conduit 30 into the second chamber 20.

FIG. 5 shows the final state in which the liquid contained in the stick pack 60 has been completely transferred from the first chamber 10 to the second chamber 20 via the liquid-conducting conduit 30.

1. A method for the complete transfer of a liquid received by a first cavity of a centrifugal microfluidic biochip into a second cavity of the centrifugal microfluidic biochip by a liquid-conducting conduit connecting the first cavity to the second cavity, comprising:
a. generating a predetermined gas and/or vapor pressure driving the liquid received by the first cavity from the first cavity through the liquid-carrying conduit to the second cavity by adjusting the first cavity to a first predetermined temperature while simultaneously adjusting a gas-filled third cavity, which is connected to the first cavity by a gas-carrying conduit, to a second predetermined temperature which is lower than the first predetermined temperature,
b. generating a predetermined gas pressure in the third cavity by adjusting the third cavity to a third predetermined temperature, and
c. allowing the gas pressure generated in the third cavity to act on the interior of the first cavity by means of the gas-conducting conduit connecting the third cavity to the first cavity and thereby causing the liquid received by the first cavity to be completely transferred from the first cavity through the liquid-conducting conduit into the second cavity.

2. The method according to claim 1, wherein the method takes place with simultaneous rotation of the centrifugal microfluidic biochip.

3. The method according to claim 1, wherein step a. takes place with simultaneous rotation of the centrifugal microfluidic biochip at a predetermined first rotational frequency.

4. The method according to claim 1, wherein step b. and/or step c. takes place with simultaneous rotation of the centrifugal microfluidic biochip at a predetermined second rotational frequency.

5. The method according to claim 3, wherein the second rotational frequency is lower than the first rotational frequency.

6. The method according to claim 1, wherein step b. or step c. comprises acting on a device controlling the passage of gases through the gas-carrying conduit as a result of which tempered gas in the third cavity passes through the gas-carrying conduit into the first cavity.

7. A system comprising
a Centrifugal Microfluidic Biochip having
a temperature-controllable first cavity designed to receive a liquid,
a second cavity designed to receive liquid pumped from the first cavity into the second cavity, and
a liquid-conducting conduit connecting the first cavity to the second cavity,
gas-filled third cavity connected to the first cavity by means of an exclusively gas-conducting conduit, and
a centrifuge having
a receptacle receiving the centrifugal microfluidic biochip, having
a first device for temperature control of the first cavity of the centrifugal microfluidic biochip and
a second device for temperature control of the third cavity of the centrifugal microfluidic biochip,
a controller which is designed
in a first step for generating a predetermined gas and/or vapor pressure driving a liquid received by the first cavity from the first cavity through the liquid-carrying conduit to the second cavity by adjusting the first cavity to a first predetermined temperature while simultaneously adjusting the gas-filled third cavity to a second predetermined temperature which is lower than the first predetermined temperature, and,
in a second step for generating a predetermined gas pressure in the third cavity by adjusting the third cavity to a third predetermined temperature,
in order to transfer the liquid received by the first cavity from the first cavity completely into the second cavity through the liquid-conducting conduit.

8. The system according to claim 7, wherein the control is designed to act on a device controlling the passage of gases through the gas-conducting conduit.

9. The system according to claim 8, wherein the device is designed as a check valve or as a temperature-instable septum.

10. The system according to claim 7, wherein the centrifugal microfluidic biochip comprises an electrically conductive first heating element for temperature control of the first cavity and an electrically conductive second heating element for temperature control of the third cavity and the centrifuge comprises at least one magnet for generating an electric current in the first heating element and in the second heating element.

11. The system according to claim 7, wherein the first cavity is designed to receive a liquid-filled stick pack or a liquid-filled stick pack is arranged in the first cavity.

12. The system according to claim 7, wherein the third cavity is blind-ended.

13. The system according to claim 7, wherein the first cavity and/or the second cavity are a chamber or a liquid-carrying conduit.
